(19) United States
(12) Patent Application Publication
(10) Pub. No.: US 2021/0183381 A1
(43) Pub. Date: Jun. 17, 2021

(54) DEPICTING CHARACTER DIALOGUE WITHIN ELECTRONIC TEXT

(71) Applicant: INTERNATIONAL BUSINESS MACHINES CORPORATION, Armonk, NY (US)

(72) Inventors: John E. Petri, St. Charles, MN (US); Adam T. Clark, Mantorville, MN (US); Jeffrey Kenneth Huebert, Byron, MN (US)

(21) Appl. No.: 16/715,536

(22) Filed: Dec. 16, 2019

(51) Int. Cl. G10L 15/22; G06F 16/901; G06F 3/01; G10L 15/18; G06F 3/0484; G06F 3/16

(52) U.S. Cl. CPC G10L 15/22; G06F 16/9024; G06F 3/013; G10L 2015/223; G06F 3/0484; G06F 3/167; G10L 15/1815

(57) ABSTRACT

A computer-implemented method for depicting character dialogue within a story. The computer-implemented method includes identifying dialogue between one or more characters in the story using one or more natural langue processing techniques. The computer-implemented method further includes creating a knowledge graph, wherein the knowledge graph comprises each of the one or more characters in the story, a relationship between each of the one or more characters in the story, and a role for each of the one or more characters in the story. The computer-implemented method further includes depicting the dialogue between the one or more characters, based on one or more characteristics of the one or more characters during the dialogue.

### BACKGROUND

The present disclosure relates generally to the field of cognitive computing, natural language processing (NLP), and more particularly to data processing and dynamic depiction of character dialogue within electronic text.

The electronic book market has steadily increased over the last decade with various applications that enable users to download books right onto their computing devices.

However, oftentimes a reader, while reading a book that contains a lot of character dialogue, gets confused as to which character is currently speaking or the manner in which they are speaking.

### BRIEF SUMMARY

Embodiments of the present invention disclose a method, a computer program product, and a system.

A method, according to an embodiment of the invention, in a data processing system including a processor and a memory, for implementing a program that depicts character dialogue within a story. The method includes identifying dialogue between one or more characters in the story using one or more natural langue processing techniques. The method further includes creating a knowledge graph, wherein the knowledge graph comprises each of the one or more characters in the story, a relationship between each of the one or more characters in the story, and a role for each of the one or more characters in the story. The method further includes depicting the dialogue between the one or more characters, based on one or more characteristics of the one or more characters during the dialogue.

A computer program product, according to an embodiment of the invention, includes a non-transitory tangible storage device having program code embodied therewith. The program code is executable by a processor of a computer to perform a method. The method includes identifying dialogue between one or more characters in the story using one or more natural langue processing techniques. The method further includes creating a knowledge graph, wherein the knowledge graph comprises each of the one or more characters in the story, a relationship between each of the one or more characters in the story, and a role for each of the one or more characters in the story. The method further includes depicting the dialogue between the one or more characters, based on one or more characteristics of the one or more characters during the dialogue.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method includes identifying dialogue between one or more characters in the story using one or more natural langue processing techniques. The method further includes creating a knowledge graph, wherein the knowledge graph comprises each of the one or more characters in the story, a relationship between each of the one or more characters in the story, and a role for each of the one or more characters in the story. The method further includes depicting the dialogue between the one or more characters, based on one or more characteristics of the one or more characters during the dialogue.

### BRIEF DESCRIPTION OF THE DRAWINGS

FIG. 1 illustrates a dialogue depiction computing environment, in accordance with an embodiment of the present invention.

FIG. 2 is a flowchart illustrating the operation of dialogue depiction program of FIG. 1, in accordance with an embodiment of the present invention.

FIG. 3 is an illustrative example depicting dialogue between various characters in a story, in accordance with an embodiment of the present invention.

FIG. 4 is a diagram graphically illustrating the hardware components of dialogue depiction computing environment of FIG. 1, in accordance with an embodiment of the present invention.

FIG. 5 depicts a cloud computing environment, in accordance with an embodiment of the present invention.

FIG. 6 depicts abstraction model layers of the illustrative cloud computing environment of FIG. 5, in accordance with an embodiment of the present invention.

### DETAILED DESCRIPTION

As discussed herein, oftentimes a reader, while reading a book that contains a lot of character dialogue, gets confused as to which character is currently speaking or the manner in which they are speaking. The reader must mentally adjust for multiple character dialogues in multiple contexts, especially in a complex book with many characters and a lot of dialogue. This confusion can disrupt a reader's flow and make reading much less enjoyable.

The problem of a reader getting confused as to which character is currently speaking or the manner in which they are speaking, also presents itself when reading aloud. For example, when a parent reads a book aloud to their children, the story would be much more entertaining if the parent could easily switch personas, change volume, pitch, pace, accent, etc. during the dialogue parts.

The present invention discloses a method that dynamically depicts character dialogue within a story, thus making book reading a much more enjoyable experience for the reader and/or the audience.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

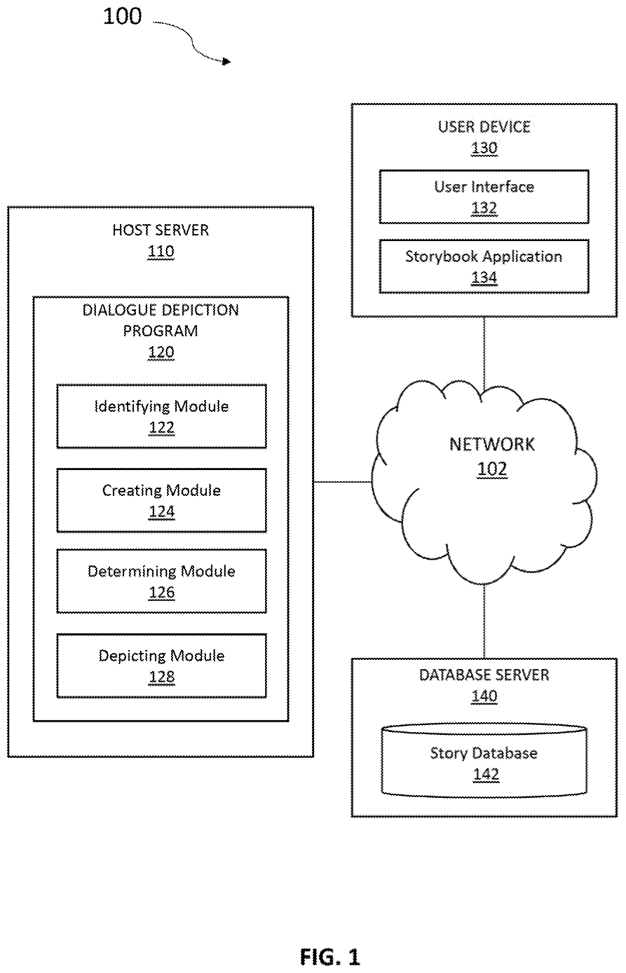

FIG. 1 illustrates dialogue depiction computing environment 100, in accordance with an embodiment of the present invention. Dialogue depiction computing environment 100 includes host server 110, user device 130, and database server 140, connected via network 102. The setup in FIG. 1 represents an example embodiment configuration for the present invention, and is not limited to the depicted setup in order to derive benefit from the present invention.

In an exemplary embodiment, network 102 is a communication channel capable of transferring data between connected devices and may be a telecommunications network used to facilitate telephone calls between two or more parties comprising a landline network, a wireless network, a closed network, a satellite network, or any combination thereof. In another embodiment, network 102 may be the Internet, representing a worldwide collection of networks and gateways to support communications between devices connected to the Internet. In this other embodiment, network 102 may include, for example, wired, wireless, or fiber optic connections which may be implemented as an intranet network, a local area network (LAN), a wide area network (WAN), or any combination thereof. In further embodiments, network 102 may be a Bluetooth® (Bluetooth and all Bluetooth-based trademarks and logos are trademarks or registered trademarks of Bluetooth SIG, Inc. and/or its affiliates) network, an IoT network, a WiFi network, or a combination thereof. In general, network 102 can be any combination of connections and protocols that will support communications between host server 110, user device 130, and database server 140.

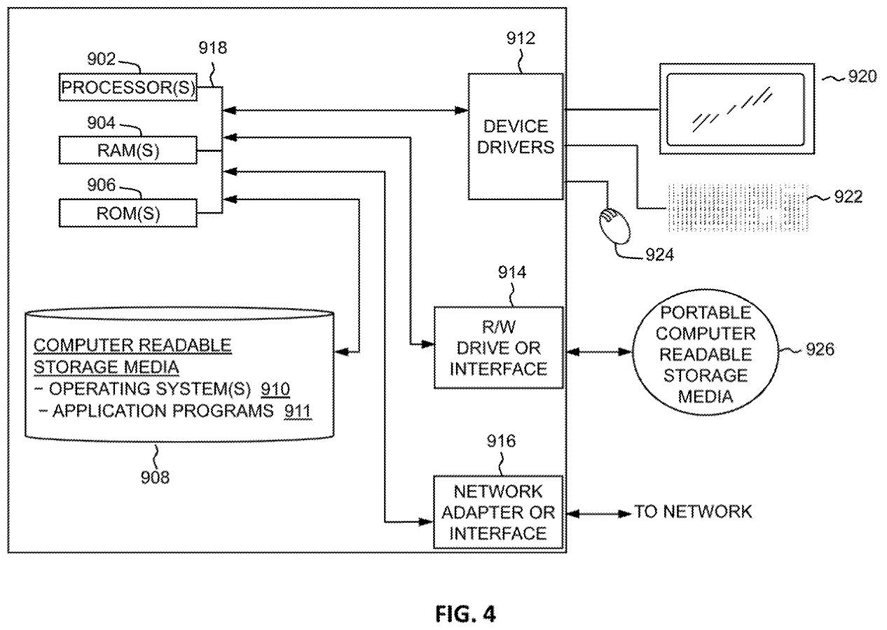

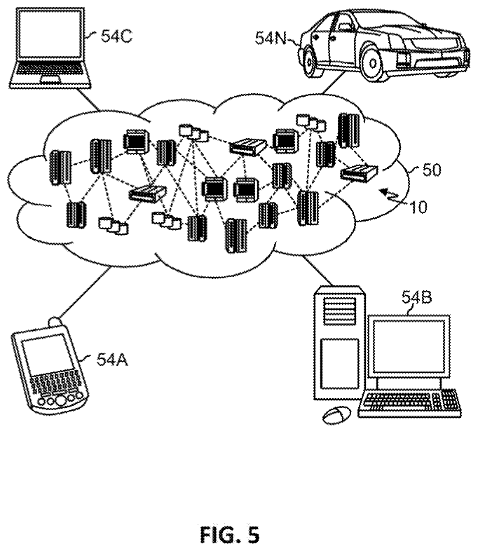

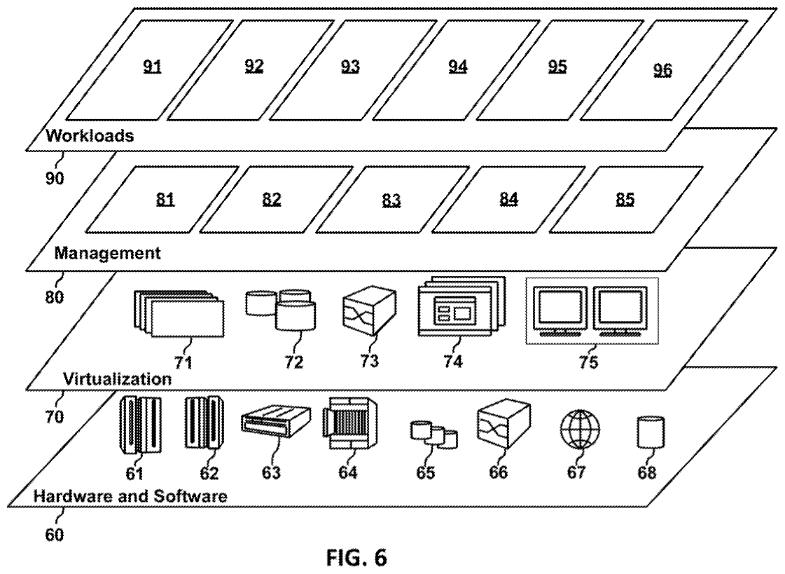

In an exemplary embodiment, host server 110 contains dialogue depiction program 120. In various embodiments, host server 110 may be a laptop computer, tablet computer, netbook computer, personal computer (PC), a desktop computer, a personal digital assistant (PDA), a smart phone, a server, or any programmable electronic device capable of communicating with user device 130 and database server 140, via network 102. Host server 110 may include internal and external hardware components, as depicted and described in further detail below with reference to FIG. 4. In other embodiments, host server 110 may be implemented in a cloud computing environment, as described in relation to FIGS. 5 and 6, herein. Host server 110 may also have wireless connectivity capabilities allowing it to communicate with user device 130, database server 140, and other computers or servers over network 102.

With continued reference to FIG. 1, user device 130 contains user interface 132 and storybook application 134. In various embodiments, user device 130 may be a laptop computer, tablet computer, netbook computer, personal computer (PC), a desktop computer, a personal digital assistant (PDA), a smart phone, a smart watch, an e-book, or any programmable electronic device capable of communicating with host server 110 and database server 140, via network 102. User device 130 may include internal and external hardware components, as depicted and described in further detail below with reference to FIG. 4. In other embodiments, user device 130 may be implemented in a cloud computing environment, as described in relation to FIGS. 5 and 6, herein. User device 130 may also have wireless connectivity capabilities allowing it to communicate with host server 110, database server 140, and other computers or servers over network 102.

In an exemplary embodiment, user device 130 includes user interface 132, which may be a computer program that allows a user to interact with user device 130 and other connected devices via network 102. For example, user interface 132 may be a graphical user interface (GUI). In addition to comprising a computer program, user interface 132 may be connectively coupled to hardware components, such as those depicted in FIG. 4, for receiving user input. In an exemplary embodiment, user interface 132 is a web browser, however in other embodiments user interface 132 may be a different program capable of receiving user interaction and communicating with other devices.

In an exemplary embodiment, storybook application 134 may be a software program, on user device 130, that includes electronic text content, involving dialogue between various characters (e.g., e-books, audiobooks, and so forth). Storybook application 134 is not limited to electronic text content, but rather may include other forms of character dialogue content known to one of ordinary skill in the art.

Storybook application 134, in exemplary embodiments, is capable of communicating with host server 110, user device 130, and database server 140 via network 102.

With continued reference to FIG. 1, database server 140 includes story database 142 and may be a laptop computer, tablet computer, netbook computer, personal computer (PC), a desktop computer, a personal digital assistant (PDA), a smart phone, a server, or any programmable electronic device capable of communicating with host server 110, user device 130, and database server 140, via network 102. While database server 140 is shown as a single device, in other embodiments, database server 140 may be comprised of a cluster or plurality of computing devices, working together or working separately.

In an exemplary embodiment, story database 142 may represent a database management system and store, in memory, various types of content having different container formats such as text documents, movie files, and any other known content container format in the art that is capable of conveying dialogue between one or more characters.

In exemplary embodiments, story database 142 may further include annotated content of identified dialogue between one or more characters in a particular story, knowledge graphs depicting relationships and roles of the characters in the particular story, and other content identified via natural language processing (NLP) techniques, as will be further discussed below with relation to the functional modules of dialogue depiction program 120.

While story database 142 is depicted as being located on database server 140, in other embodiments, story database 142 may be stored on host server 110, user device 130, or any other device or database connected via network 102, as a separate database. In alternative embodiments, story database 142 may be comprised of a cluster or plurality of computing devices, working together or working separately.

With continued reference to FIG. 1, dialogue detection program 120, in an exemplary embodiment, may be a software application on host server 110 that contains instruction sets, executable by a processor. The instruction sets may be described using a set of functional modules. In exemplary embodiments, dialogue detection program 120 may receive input from user device 130 and database server 140, via network 102. In alternative embodiments, dialogue detection program 120 may be a standalone program on a separate electronic device, such as user device 130.

With continued reference to FIG. 1, the functional modules of dialogue detection program 120 include identifying module 122, creating module 124, determining module 126, and depicting module 128.

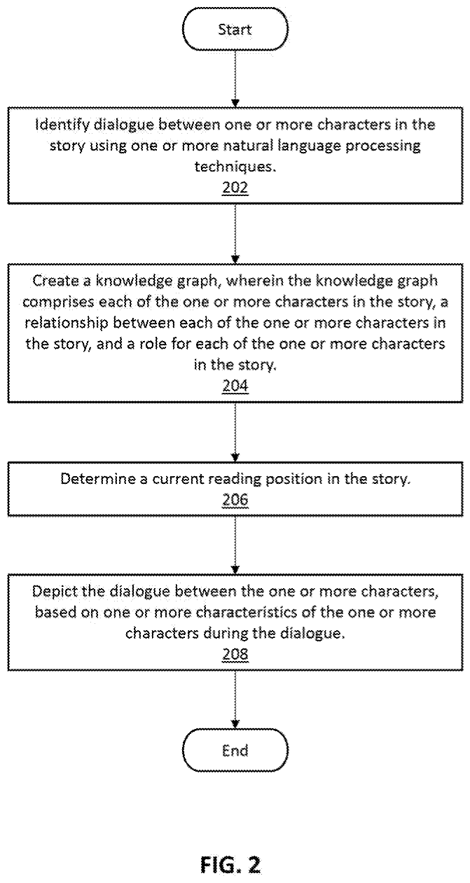

FIG. 2 is a flowchart illustrating the operation of dialogue depiction program 120 of FIG. 1, in accordance with an embodiment of the present invention.

Dialogue depiction program 120 utilizes natural language processing techniques to identify character dialogue within a story (e.g., e-book), creates a knowledge graph connecting the one or more characters in the story (e.g., relationship between the characters, character roles, and so forth), and visually depicts the identified dialogue between the one or more characters in a fashion that enables the reader to associate an appropriate sentiment to current character dialogue (via color coding, character avatars, etc.).

With reference to FIGS. 1 and 2, identifying module 122 includes a set of programming instructions in dialogue detection program 120, to identify dialogue between one or more characters in the story using one or more natural language processing techniques (step 202). NLP techniques (e.g., part of speech tagging, tokenization, feature extraction, modeling, etc.) for identifying character dialogue within text, together with an associated sentiment of the character speaking, are generally known to one of ordinary skill in the art.

The present invention builds on established NLP techniques to assist in understanding natural language. Currently, there exist solutions that can automatically annotate or summarize text using NLP. The present invention seeks to describe a novel solution which builds on NLP capabilities, specifically with regards to isolating character dialogue, determining a character role of the character, and dialogue sentiment of each character engaged in the dialogue.

In exemplary embodiments, identifying module 122 receives input from storybook application 134 and story database 142.

With reference to an illustrative example, Larry is reading a bedtime story, via an e-book application on his user device, to his daughter and wants to keep her engaged in the story. Larry decides to act out character dialogue while he is reading (e.g., to read in the voice of how the character's role is depicted in the story). For example, Larry acts out the character's dialogue based on whether the character is a villain (e.g., low, evil voice), a superhero (e.g., upbeat and positive voice), and so forth. However oftentimes it is difficult for Larry to know which character is speaking without having to read a few lines into the dialogue and then having to change his voice over into character-mode, which ultimately disrupts the flow of the story telling. Identifying module 122 is capable of “reading ahead” and identifying all of the character dialogue in the bedtime story, for example, via pre-annotating a book with specific character dialogue indicators (e.g., color coding dialogue text, inserting avatars next to character text, and so forth).

With continued reference to FIGS. 1 and 2, creating module 124 includes a set of programming instructions in dialogue detection program 120, to create a knowledge graph, wherein the knowledge graph comprises each of the one or more characters in the story, a relationship between each of the one or more characters in the story, and a role for each of the one or more characters in the story (step 204). The set of programming instructions is executable by a processor.

In exemplary embodiments, the created knowledge graph is not limited to connected relationships and roles of characters in the story, but may further include any attributes (e.g., friendly, sympathetic, arrogant, and so forth), storylines, or any other pre-configured characteristics of the story, and/or characters within the story, that are deemed appropriate for inclusion.

In alternative embodiments, creating module 124 may further gather crowd-sourced information and other media related to the one or more characters in the story, match the crowd-sourced information and other media with the created knowledge graph, and augment the characteristics (e.g., personas and sentiment) of the one or more characters based on the match.

With continued reference to the illustrative example, creating module 124 creates a knowledge graph of all of the characters in the bedtime story, their roles, and how they are connected to one another pursuant to the storyline. The created knowledge graph is helpful in assisting dialogue depiction program 120 develop accurate character to character dialogue (e.g., adversarial, friendly, etc.) since the knowledge graph includes all of the character insights (e.g., character transformations from the beginning to the end of the story, such as an evil character transforming into a charitable character later in the story) gleaned from the benefit of “reading ahead” (i.e., analyzing the complete text of the story) and knowing the entire storyline, as determined by subject matter experts. For example, subject matter experts may read the story and tag the dialogue for accurate character cues (e.g., friendly, evil, enticing, etc.). In exemplary embodiments, the tagged data may be stored in story database 142 and accessible by dialogue depiction program 120, via network 102.

With continued reference to FIGS. 1 and 2, determining module 126 includes a set of programming instructions in dialogue depiction program 120, to determine a current reading position in the story (step 206). The set of programming instructions is executable by a processor. Determining a current reading position of a user is one embodiment. In other exemplary embodiments, the current reading position of a user is not necessary, since the character dialogue may be pre-annotated with specific character dialogue indicators (e.g., color coding dialogue text, inserting avatars next to character text, and so forth).

In exemplary embodiments, determining module 126 may be useful for electronic books (e-books) in order to, for example, dynamically add sentiment cues as the user is reading.

In alternative embodiments, a current reading position in the story may be based on voice analysis and eye-tracking of a user. For example, user device 130, or the device that is displaying the electronic text, may include a microphone and/or camera capable of processing the voice of the user (i.e., reader). For example, NLP techniques, known to one of ordinary skill in the art, may be capable of matching a string of the user's spoken words to the electronic text on the user device 130.

In further alternative embodiments, determining module 126 may be capable of detecting, via a camera, eye-tracking movements of the user, while reading the electronic text (i.e., eye gazing location on the display to determine a specific paragraph (or words) that the user is looking at based on knowing the screen location and matching the eye gazing location of the user to the location of the specific paragraph on the page that is currently displayed). In this way, determining module 126 is capable of determining the current reading position in the story.

In alternative embodiments, a current reading position of the user is not limited to voice analysis and eye-tracking technology, but rather may include any other technology capable of determining a user's current reading position, known to one of ordinary skill in the art.

With continued reference to FIGS. 1 and 2, depicting module 128 includes a set of programming instructions in dialogue depiction program 120, to depict the dialogue between the one or more characters, based on one or more characteristics of the one or more characters during the dialogue (step 208). The set of programming instructions is executable by a processor.

In exemplary embodiments, the one or more characteristics of the one or more characters during the dialogue may further include displaying a current sentiment (e.g., happy, sad, angry, etc.) for the one or more characters during the dialogue. The current sentiment for the one or more characters during the dialogue is obtained by identifying module 122 via NLP techniques known to one of ordinary skill in the art, and stored in story database 142 as a created knowledge graph. For example, the created knowledge graph may indicate that the sentiment for the one or more characters may be different at different time periods in the story, or when the characters are engaged in dialogue with various other characters, and thus depict appropriate and relevant character sentiment at various points of dialogue throughout the story.

In exemplary embodiments, depicting module 128 may depict various sentiments via a color-coded key on the electronic text page. For example, a grey color may indicate neutral (e.g., normal voice), yellow may indicate irritated (e.g., whiney voice), red may indicate angry (e.g., loud, mean voice), green may indicate scared (e.g., throaty voice), and so forth. In this fashion, the reader knows how to inflect their voice (e.g., use an accent, raise voice, whisper, etc.) when they see a color-coded indicator next to the character dialogue.

In various alternative embodiments, depicting various sentiments for character dialogue is not limited to color-coded indicators, but rather may include any type or form of indicator (e.g., symbol, number scale, etc.), known to one of ordinary skill in the art, capable of depicting character sentiment.

In further exemplary embodiments, depicting the dialogue between the one or more characters may be represented to the user in various other ways.

In exemplary embodiments, depicting module 128 depicts the dialogue between the one or more characters by highlighting the dialogue between the one or more different characters using one or more various colors that are specific to the one or more different characters. In this fashion, the reader knows, right away, which character is speaking based on the associated color of the electronic text associated with that character.

With reference to the illustrative example above, Larry is reading a cartoon e-book to his daughter. In order to better assist Larry in knowing which character is speaking, while Larry is reading the story, the dialogue between character 1 and character 2 may be highlighted as follows: green text indicates that character 1 is speaking, and red text indicates that character 2 is speaking. In this fashion, Larry can easily switch personas between characters. Larry uses a Brooklyn accent to say “Hi there, buddy!” while reading in the voice of character 2 and switches into a 1930's-era vaudeville voice to say “Shh. It's early in the morning. I don't want to wake the animals!” while reading in the voice of character 1.

In further exemplary embodiments, depicting module 128 depicts the dialogue between the one or more characters by displaying a character avatar and contextual information (e.g., male/female character, scruffy voice, low voice, whiny voice, etc.) for the one or more characters next to the dialogue for the one or more characters.

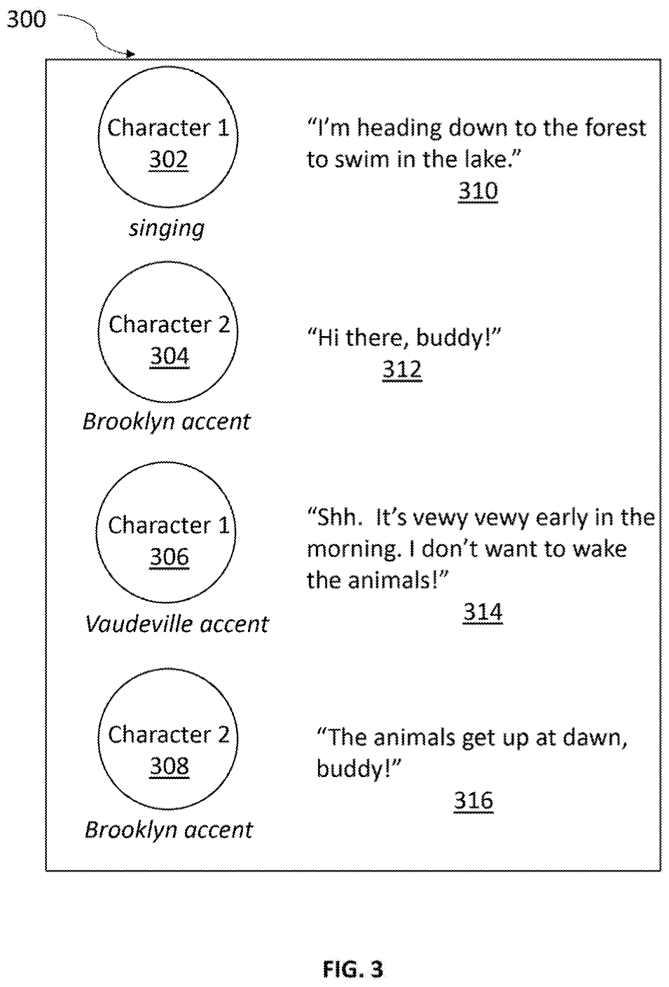

FIG. 3 is an illustrative example of a page 300 depicting dialogue between various characters in storybook application 134, in accordance with an embodiment of the present invention.

With reference to the illustrative example of FIG. 3, depicting module 128 depicts dialogue between character 1 and character 2 by displaying a character avatar and contextual information (e.g., singing, accent, etc.) next to the dialogue for the one or more characters. An avatar of character 1 302 is displayed next to dialogue 310 “I'm heading to the forest to swim in the lake.” Underneath character 1 302 avatar is the word “singing”, thereby letting Larry know that he should sing in his 1930's-era vaudeville voice at this point in the dialogue.

With continued reference to the illustrative example of FIG. 3, Larry is cued to revert back to his Brooklyn accent voice when he sees the dialogue next to the avatar of character 2 304, saying “Hi there, buddy!” 312. Again, Larry is cued to switch back to his vaudeville accent when reading the dialogue next to the avatar of character 1 306, saying “Shh. It's vewy vewy early in the morning. I don't want to wake the animals!” 314. Reading further in the dialogue, Larry switches back to his Brooklyn accent when reading the dialogue next to the avatar of character 2 308, “The animals get up at dawn, buddy!” 316.

In further embodiments, depicting module 128 may also depict contextual information next to the avatar, further clueing the reader as to a current state of the character in the dialogue. For example, if the character is ill during the dialogue, then “coughing voice” may be indicated next to the ill character's dialogue. The sign post words (e.g., “coughing”, “throaty”, “scruffy voice”, “whiney”, and so forth) next to the character dialogue enable a more seamless and realistic dialogue experience to take place for both the reader and the reader's audience.

In various exemplary embodiments, dialogue depiction program 120 may display the one or more characteristics of the one or more characters during the dialogue based on a pre-configured display option, wherein the pre-configured display option is selected from a group consisting of highlighting different character dialogue using one or more unique colors, displaying a character avatar next to a corresponding character dialogue, and displaying a current sentiment of the one or more characters next to the corresponding character dialogue.

FIG. 4 is a block diagram depicting components of a computing device (such as host server 110, as shown in FIG. 1), in accordance with an embodiment of the present invention. It should be appreciated that FIG. 4 provides only an illustration of one implementation and does not imply any limitations with regard to the environments in which different embodiments may be implemented. Many modifications to the depicted environment may be made.

The computing device of FIG. 4 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as dialogue depiction program 120, may be stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The computing device of FIG. 4 may also include a R/W drive or interface 914 to read from and write to one or more portable computer readable storage media 926. Application programs 911 on the computing device may be stored on one or more of the portable computer readable storage media 926, read via the respective R/W drive or interface 914 and loaded into the respective computer readable storage media 908.

The computing device of FIG. 4 may also include a network adapter or interface 916, such as a TCP/IP adapter card or wireless communication adapter (such as a 4G wireless communication adapter using OFDMA technology). Application programs 911 on the computing device may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

The computing device of FIG. 4 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and controlling access to data objects 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present invention. Therefore, the present invention has been disclosed by way of example and not limitation.

1. A computer-implemented method for depicting character dialogue within a story, comprising:
identifying dialogue between one or more characters in the story using one or more natural language processing techniques;
creating a knowledge graph, wherein the knowledge graph comprises each of the one or more characters in the story, a relationship between each of the one or more characters in the story, and a role for each of the one or more characters in the story; and
depicting the dialogue between the one or more characters, based on one or more characteristics of the one or more characters during the dialogue.

2. The computer-implemented method of claim 1, further comprising:
determining a current reading position in the story based on voice analysis and eye-tracking of a user; and
adding, dynamically, one or more sentiment cues based on the determined current reading position in the story.

3. The computer-implemented method of claim 1, wherein depicting the dialogue between the one or more characters further comprises:
highlighting the dialogue between one or more different characters using one or more various colors that are specific to the one or more different characters.

4. The computer-implemented method of claim 1, wherein depicting the dialogue between the one or more characters further comprises:
displaying a character avatar and contextual information for the one or more characters, next to the dialogue for the one or more characters.

5. The computer-implemented method of claim 1, wherein the one or more characteristics of the one or more characters during the dialogue, further comprises:
displaying a current sentiment for the one or more characters during the dialogue.

6. The computer-implemented method of claim 1, further comprising:
gathering crowd-sourced information and other media related to the one or more characters in the story;
matching the crowd-sourced information and other media with the created knowledge graph; and
augmenting the characteristics of the one or more characters based on the matching.

7. The computer-implemented method of claim 1, further comprising:
displaying the one or more characteristics of the one or more characters during the dialogue based on a pre-configured display option, wherein the preconfigured display option is selected from a group consisting of highlighting different character dialogue using one or more unique colors, displaying a character avatar next to a corresponding character dialogue, and displaying a current sentiment of the one or more characters next to the corresponding character dialogue.

8. A computer program product for depicting character dialogue within a story, comprising a non-transitory tangible storage device having program code embodied therewith, the program code executable by a processor of a computer to perform a method, the method comprising:
identifying dialogue between one or more characters in the story using one or more natural language processing techniques;
creating a knowledge graph, wherein the knowledge graph comprises each of the one or more characters in the story, a relationship between each of the one or more characters in the story, and a role for each of the one or more characters in the story; and
depicting the dialogue between the one or more characters, based on one or more characteristics of the one or more characters during the dialogue.

9. The computer program product of claim 8, further comprising:
determining a current reading position in the story based on voice analysis and eye-tracking of a user; and
adding, dynamically, one or more sentiment cues based on the determined current reading position in the story.

10. The computer program product of claim 8, wherein depicting the dialogue between the one or more characters further comprises:
highlighting the dialogue between one or more different characters using one or more various colors that are specific to the one or more different characters.

11. The computer program product of claim 8, wherein depicting the dialogue between the one or more characters further comprises:
displaying a character avatar and contextual information for the one or more characters, next to the dialogue for the one or more characters.

12. The computer program product of claim 8, wherein the one or more characteristics of the one or more characters during the dialogue, further comprises:
displaying a current sentiment for the one or more characters during the dialogue.

13. The computer program product of claim 8, further comprising:
gathering crowd-sourced information and other media related to the one or more characters in the story;
matching the crowd-sourced information and other media with the created knowledge graph; and
augmenting the characteristics of the one or more characters based on the matching.

14. The computer program product of claim 8, further comprising:
displaying the one or more characteristics of the one or more characters during the dialogue based on a pre-configured display option, wherein the preconfigured display option is selected from a group consisting of highlighting different character dialogue using one or more unique colors, displaying a character avatar next to a corresponding character dialogue, and displaying a current sentiment of the one or more characters next to the corresponding character dialogue.

15. A computer system for depicting character dialogue within a story, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
identifying dialogue between one or more characters in the story using one or more natural language processing techniques;
creating a knowledge graph, wherein the knowledge graph comprises each of the one or more characters in the story, a relationship between each of the one or more characters in the story, and a role for each of the one or more characters in the story; and
depicting the dialogue between the one or more characters, based on one or more characteristics of the one or more characters during the dialogue.

16. The computer system of claim 15, further comprising:
determining a current reading position in the story based on voice analysis and eye-tracking of a user; and
adding, dynamically, one or more sentiment cues based on the determined current reading position in the story.

17. The computer system of claim 15, wherein depicting the dialogue between the one or more characters further comprises:
highlighting the dialogue between one or more different characters using one or more various colors that are specific to the one or more different characters.

18. The computer system of claim 15, wherein depicting the dialogue between the one or more characters further comprises:
displaying a character avatar and contextual information for the one or more characters, next to the dialogue for the one or more characters.

19. The computer system of claim 15, wherein the one or more characteristics of the one or more characters during the dialogue, further comprises:
displaying a current sentiment for the one or more characters during the dialogue.

20. The computer system of claim 15, further comprising:
gathering crowd-sourced information and other media related to the one or more characters in the story;
matching the crowd-sourced information and other media with the created knowledge graph; and
augmenting the characteristics of the one or more characters based on the matching.
